(19) United States
(12) Patent Application Publication
(10) Pub. No.: US 2018/0190955 A1
(43) Pub. Date: Jul. 5, 2018

(54) BATTERY PACK AND POWER SUPPLY DEVICE

(71) Applicant: CALSONIC KANSEI CORPORATION, Saitama-shi, Saitama (JP)

(72) Inventors: Toshiyuki MOTOHASHI, Saitama-shi, Saitama (JP); Satoshi SAKUMA, Saitama-shi, Saitama (JP); Yuuichirou NOMURA, Saitama-shi, Saitama (JP)

(73) Assignee: CALSONIC KANSEI CORPORATION, Saitama-shi, Saitama (JP)

(21) Appl. No.: 15/738,246

(22) PCT Filed: Jun. 21, 2016
(86) PCT No.: PCT/JP2016/002984

§ 371 Date: Dec. 20, 2017

(30) Foreign Application Priority Data
Jun. 22, 2015 (JP) 2015-125025

(51) Int. Cl. H01M 2/10

(52) U.S. Cl. CPC H01M 2/1077; H01M 2220/20

(57) ABSTRACT

A battery pack and a power supply device readily and appropriately hold batteries. A battery pack (200) according to the present disclosure includes an insulating first case (241) and an insulating second case (243), and a metal restraining plate (220) that, by being fixed to the second case (243), causes a plurality of batteries (250) to be sandwiched by the first case (241) and the second case (243) and supports the plurality of batteries (250).

### CROSS-REFERENCE TO RELATED APPLICATION

The present application claims priority to and the benefit of Japanese Patent Application No. 2015-125025 filed Jun. 22, 2015, the entire contents of which are incorporated herein by reference.

### TECHNICAL FIELD

The present disclosure relates to a battery pack and a power supply device.

### BACKGROUND

Some chargeable/dischargeable battery units include a plurality of batteries. For example, patent literature (PTL) 1 discloses a chargeable/dischargeable battery unit that is mounted in a vehicle, such as an automobile, and includes a battery pack module. The battery unit disclosed in PTL 1 is configured to house the battery pack module in an aluminum housing base, with a restraining plate disposed on top of the battery pack module.

### CITATION LIST

### Patent Literature

PTL 1: JP 2014-013723 A

### SUMMARY

### Technical Problem

Since the battery pack module and the restraining plate in the battery unit disclosed in PTL 1 are separate bodies, however, gaps may occur between components because of differences in dimensions between components, such as variation in the thickness dimension of the battery stack or deflection of the restraining plate. In a vibration test or the like, any gaps between components could cause the batteries in the battery unit to be subjected to shock and damaged.

Furthermore, since the battery case of the battery pack module is made of resin, deflection may occur depending on the weight of the batteries being held. Therefore, mounting bus bars onto the battery terminals by welding during manufacturing of the battery unit may lead to deflection and cause stress between components after welding.

In light of these considerations, it would be helpful to provide a battery pack and a power supply device that readily and appropriately hold batteries.

### Solution to Problem

To this end, a battery pack according to a first aspect includes:

an insulating first case and an insulating second case; and

a metal restraining plate that, by being fixed to the second case, causes a plurality of batteries to be sandwiched by the first case and the second case and supports the plurality of batteries.

In a battery pack according to a second aspect, the second case has a concave shape formed by a bottom and side faces and including a space housing the plurality of batteries, and

the first case is engaged with an opening side of the concave shape of the second case.

In a battery pack according to a third aspect, the restraining plate is a flat plate and includes a bead projecting from a surface of the restraining plate and extending in one direction.

In a battery pack according to a fourth aspect, the second case includes a bead projecting from the bottom and extending along the bottom in one direction.

In a battery pack according to a fifth aspect, the first case includes a bead projecting from a top and extending along the top in a different direction than the one direction when the first case is in a state of engagement with the second case.

A battery pack according to a sixth aspect further includes a third case between the first case and the second case, wherein the third case includes flanges in contact with the side faces and a flat plate portion separating the plurality of batteries.

A power supply device according to a seventh aspect includes a battery pack inside a housing, wherein

the battery pack comprises an insulating first case and an insulating second case configured to sandwich a plurality of batteries, and a metal restraining plate fixed to the second case and configured to support the plurality of batteries, and

the second case has a concave shape formed by a bottom and side faces and comprising a space housing the plurality of batteries, the second case includes flanges on the side faces projecting towards the opposite side from the space at an opening side of the concave shape of the second case, and the second case is fixed to the housing at the flanges.

### Advantageous Effect

The first case and the second case that hold the batteries can be formed integrally with the restraining plate in the battery pack according to the first aspect. Hence, the weight of the batteries presses on the restraining plate. Since the restraining plate is made of metal, deflection caused by the weight of the batteries can more easily be prevented than when the batteries are only held by the first case and the second case that are made of resin. Therefore, the battery case can readily and appropriately hold the batteries. Furthermore, preventing deflection reduces stress between components after welding.

The battery pack according to the second aspect holds the batteries in the space of the second case. Since the restraining plate is fixed to the second case, the weight of the batteries is more reliably supported by the restraining plate.

The beads in the battery pack according to the third aspect improve the rigidity of the restraining plate that supports the batteries, thereby preventing deformation of the restraining plate.

The beads in the battery pack according to the fourth aspect improve the rigidity of the second case that sandwiches the batteries, thereby preventing deformation of the second case.

Since the beads of the first case extend in a different direction than the beads of the second case in the battery pack according to the fifth aspect, the rigidity of the battery pack as a whole increases in a plurality of directions.

The third case in the battery pack according to the sixth aspect allows stable holding within the battery pack.

The first case and the second case that hold the batteries can be formed integrally with the restraining plate in the power supply device according to the seventh aspect. Hence, the weight of the batteries presses on the restraining plate. Since the restraining plate is made of metal, deflection caused by the weight of the batteries can more easily be prevented than when the batteries are only held by the first case and the second case that are made of resin. Therefore, the battery case can readily and appropriately hold the batteries. Furthermore, the second case of the battery pack is fixed directly to the housing of the power supply device, thereby holding the battery pack more stably within the power supply device.

### BRIEF DESCRIPTION OF THE DRAWINGS

In the accompanying drawings:

FIG. 1 is an external perspective view illustrating the inside of a power supply device according to an embodiment of the present disclosure;

FIG. 2 is an exploded perspective view of each component inside the power supply device illustrated in FIG. 1;

FIG. 3 is a functional block diagram illustrating an overview of a power supply system that includes the power supply device illustrated in FIG. 1;

FIG. 4 is an external perspective view of the upper side of a four-cell stack assembly included in the power supply device illustrated in FIG. 1;

FIG. 5 is an external perspective view of the lower side of the four-cell stack assembly included in the power supply device illustrated in FIG. 1;

FIG. 6 illustrates the state of a bus bar plate as mounted on the body of the four-cell stack assembly illustrated in FIG. 4;

FIG. 7 is an exploded view of the body of the four-cell stack assembly illustrated in FIG. 4;

FIG. 8 is a front view of the bus bar plate included in the four-cell stack assembly illustrated in FIG. 4;

FIG. 9 illustrates the bus bar plate in FIG. 8 in a state with the bus bars removed;

FIG. 10 is an external perspective view at the back side of the opening valve cover illustrated in FIG. 6; and

FIG. 11 is an external perspective view of the upper side of a one-cell stack assembly included in the power supply device illustrated in FIG. 1.

### DETAILED DESCRIPTION

Embodiments of the present disclosure are described below in detail with reference to the drawings.

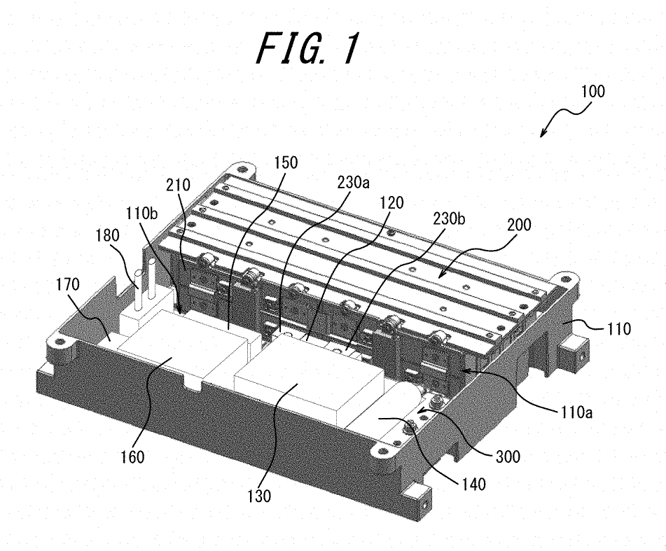

FIG. 1 is an external perspective view illustrating the inside of a power supply device according to an embodiment of the present disclosure. A power supply device 100 is configured by a housing 110 open at the top side 110a and a non-illustrated lid capable of covering the top side 110a of the housing 110. FIG. 1 illustrates the power supply device 100 with the lid removed. The housing 110 is configured by a metal such as aluminum. The housing 110 and the lid sandwich a rubber seal made of ethylene-propylene-diene monomer (EPDM) rubber or the like and are joined by an appropriate method, such as screws or clamps. The housing 110 and the lid configure the power supply device 100 by the top side 110a of the housing 110 being covered by the lid. The power supply device 100 includes the necessary components inside. These components are, for example, connected electrically. In FIG. 1, a depiction of wiring is omitted to facilitate understanding. In the present embodiment, the power supply device 100 is described as being mounted and used in a vehicle provided with an internal combustion engine or in a vehicle such as a hybrid vehicle capable of running on power from both an internal combustion engine and an electric motor. The power supply device 100 is not, however, limited to being used in a vehicle.

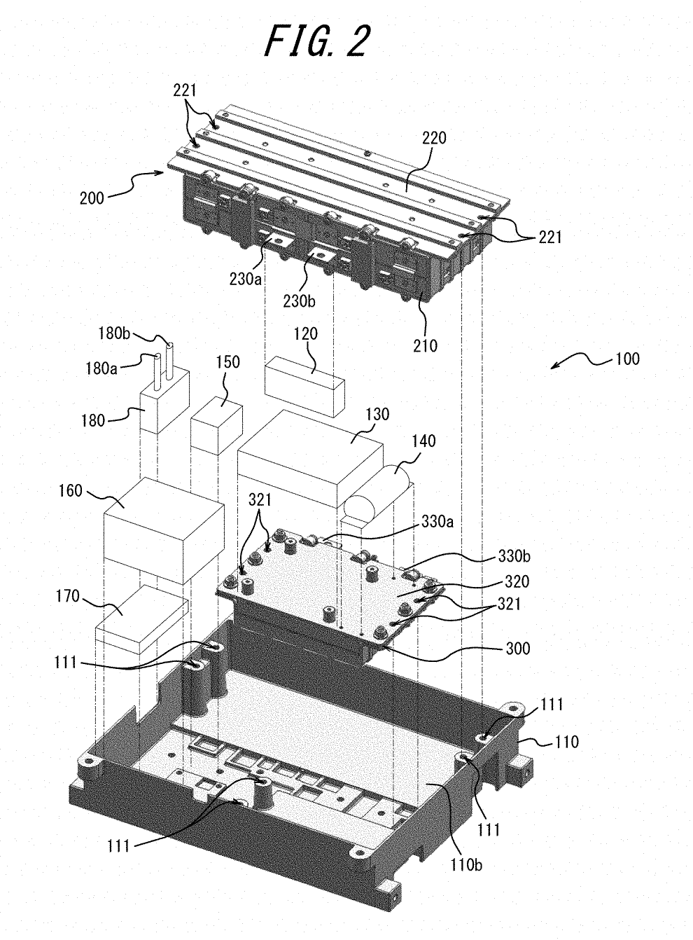

FIG. 2 is an exploded perspective view of each component inside the power supply device 100 illustrated in FIG. 1. As illustrated in FIG. 1 and FIG. 2, a substantially cuboid four-cell stack assembly 200 that includes a bus bar plate 210 on one surface and a substantially cuboid one-cell stack assembly 300 that includes a bus bar plate 310 on one surface are disposed in the housing 110 with the bus bar plate 210 and the bus bar plate 310 facing each other. In the present embodiment, the four-cell stack assembly 200 and the one-cell stack assembly 300 include respective holes 221 and 321 formed in restraining plates 220 and 320 provided at the upper portions thereof. The four-cell stack assembly 200 and the one-cell stack assembly 300 are fixed to the housing 110 by passing screws through the holes 221 and 321 and screwing the screws into holes 111 provided inside the housing 110.

The four-cell stack assembly 200 includes a positive electrode terminal 230a and a negative electrode terminal 230b that project from the bus bar plate 210. The one-cell stack assembly 300 includes a positive electrode terminal 330a and a negative electrode terminal 330b that project from the bus bar plate 310. In a state with the four-cell stack assembly 200 and the one-cell stack assembly 300 assembled with the housing 110, the negative electrode terminal 230b of the four-cell stack assembly 200 and the positive electrode terminal 330a of the one-cell stack assembly 300 are in contact.

The power supply device 100 includes a bus bar fixing terminal 120 that, in a state with the four-cell stack assembly 200 and the one-cell stack assembly 300 assembled with the housing 110, supports the positive electrode terminal 230a, the negative electrode terminal 230b, the positive electrode terminal 330a, and the negative electrode terminal 330b from the bottom 110b side.

A battery controller (LBC) 130 and a fusible link 140 are disposed at the upper portion of the one-cell stack assembly 300. The LBC 130 and the fusible link 140 are fixed to the upper portion of the one-cell stack assembly 300 with an appropriate method.

At a location on the bottom 110b of the housing 110 where the four-cell stack assembly 200 and the one-cell stack assembly 300 are not disposed, a current sensor 150, an inrush current reduction (ICR) relay 160, a metal oxide semiconductor field effect transistor (MOSFET) 170, and a terminal post 180 are provided. The current sensor 150, the ICR relay 160, the MOSFET 170, and the terminal post 180 are fixed to the bottom 110b of the housing 110 with an appropriate method. The terminal post 180 includes two terminals, for example.

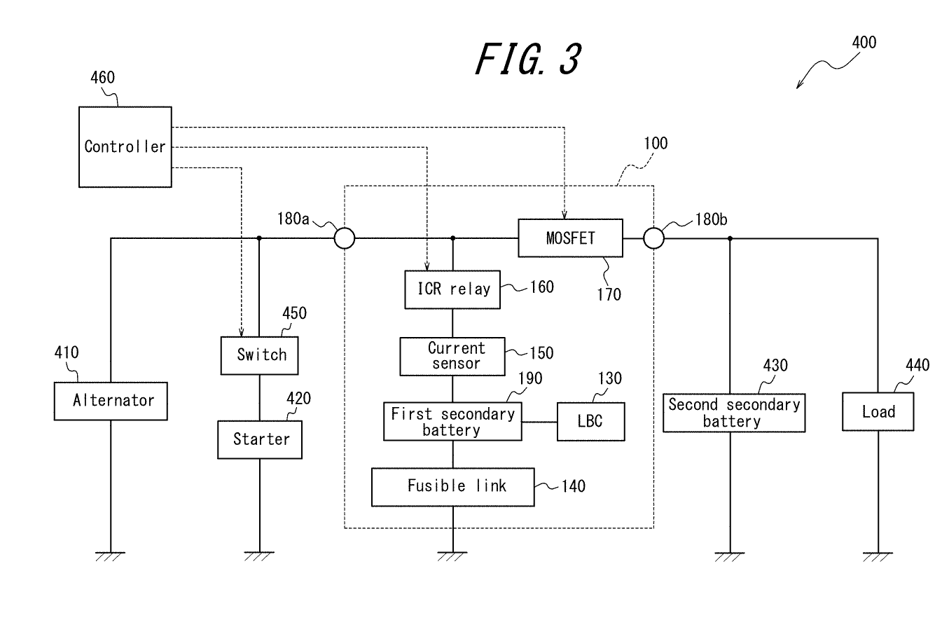

FIG. 3 is a functional block diagram illustrating an overview of a power supply system that includes the power supply device 100 illustrated in FIG. 1. A power supply system 400 includes the power supply device 100, an alternator 410, a starter 420, a second secondary battery 430, a load 440, a switch 450, and a controller 460. The power supply device 100 includes a first secondary battery 190 configured to include the four-cell stack assembly 200 and the one-cell stack assembly 300. The first secondary battery 190, the alternator 410, the starter 420, the second secondary battery 430, and the load 440 are connected in parallel.

In the power supply device 100, the ICR relay 160, the current sensor 150, the first secondary battery 190, and the fusible link 140 are connected in series in this order. In the power supply device 100, one terminal 180a of the terminal post 180 is connected to the alternator 410, and the other terminal 180b is connected to the load 440. The MOSFET 170 is connected in series with the second secondary battery 430 and the load 440.

The ICR relay 160 functions as a switch that connects or disconnects the first secondary battery 190 in parallel with constituent elements outside of the power supply device 100 in the power supply system 400.

The current sensor 150 has an appropriate structure and uses an appropriate method to measure current flowing over a path that includes the first secondary battery 190.

As described above, the first secondary battery 190 is configured to include the four-cell stack assembly 200 and the one-cell stack assembly 300. The first secondary battery 190 is, for example, a secondary battery such as a lithium-ion battery or a nickel-hydrogen battery. The first secondary battery 190 is connected to the current sensor 150 at the positive electrode side and to the fusible link 140 at the negative electrode side. In other words, the positive electrode terminal 230a of the four-cell stack assembly 200 is connected to the current sensor 150 and the negative electrode terminal 330b of the one-cell stack assembly 300 is connected to the fusible link 140 in the present embodiment.

The fusible link 140 is configured by a fuse body, a housing made of insulating resin for holding the fuse body, and a cover made of insulating resin for covering the housing. The fusible link 140 fuses when overcurrent occurs.

The MOSFET 170 functions as a switch that connects or disconnects the second secondary battery 430 and the load 440 in parallel with other constituent elements in the power supply system 400.

In the power supply device 100, the LBC 130 is connected to the first secondary battery 190 and estimates the state of the first secondary battery 190. For example, the LBC 130 estimates the state of charge (SOC) of the first secondary battery 190.

The alternator 410 is an electrical generator and is connected mechanically to the vehicle's engine. The alternator 410 generates electricity by being driven by the engine. The output voltage of the electrical power that the alternator 410 generates by being driven by the engine is adjusted by a regulator, and the electrical power is supplied to the first secondary battery 190 provided in the power supply device 100, the second secondary battery 430, the load 440, and non-illustrated auxiliary equipment in the vehicle. The alternator 410 can also generate electricity by regeneration, for example when the vehicle slows down. The electrical power that the alternator 410 generates by regeneration is used to charge the first secondary battery 190 and the second secondary battery 430.

The starter 420 is, for example, configured to include a cell motor, receives a power supply from at least one of the first secondary battery 190 and the second secondary battery 430, and starts the engine of the vehicle.

The second secondary battery 430 is configured by a lead storage battery, for example, and supplies electrical power to the load 440.

The load 440 is a load that, for example, includes the audio, air-conditioner, navigation system, and the like provided in the vehicle. The load 440 operates by consuming the supplied electrical power. The load 440 operates by receiving the electrical power supplied from the first secondary battery 190 while driving of the engine is suspended and operates by receiving the electrical power supplied from the alternator 410 and the second secondary battery 430 during driving of the engine.

The switch 450 is connected in series to the starter 420. The switch 450 connects or disconnects the starter 420 in parallel with other constituent elements.

The controller 460 controls overall operations of the power supply system 400. The controller 460 is, for example, configured by the electric control unit or engine control unit (ECU) of the vehicle. The controller 460 controls operations of the switch 450, the ICR relay 160, and the MOSFET 170. In this manner, the controller 460 supplies power with the alternator 410, the first secondary battery 190, and the second secondary battery 430 and also charges the first secondary battery 190 and the second secondary battery 430.

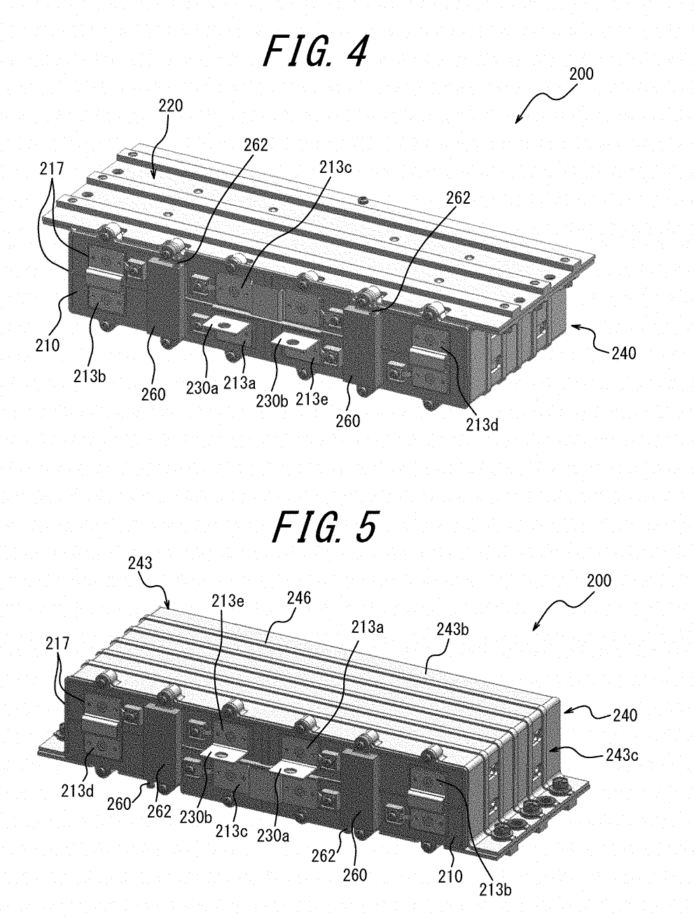

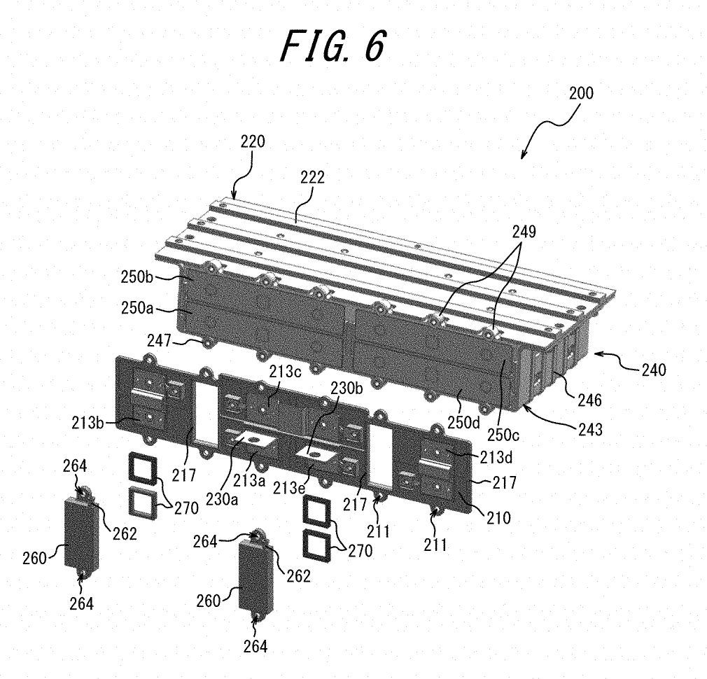

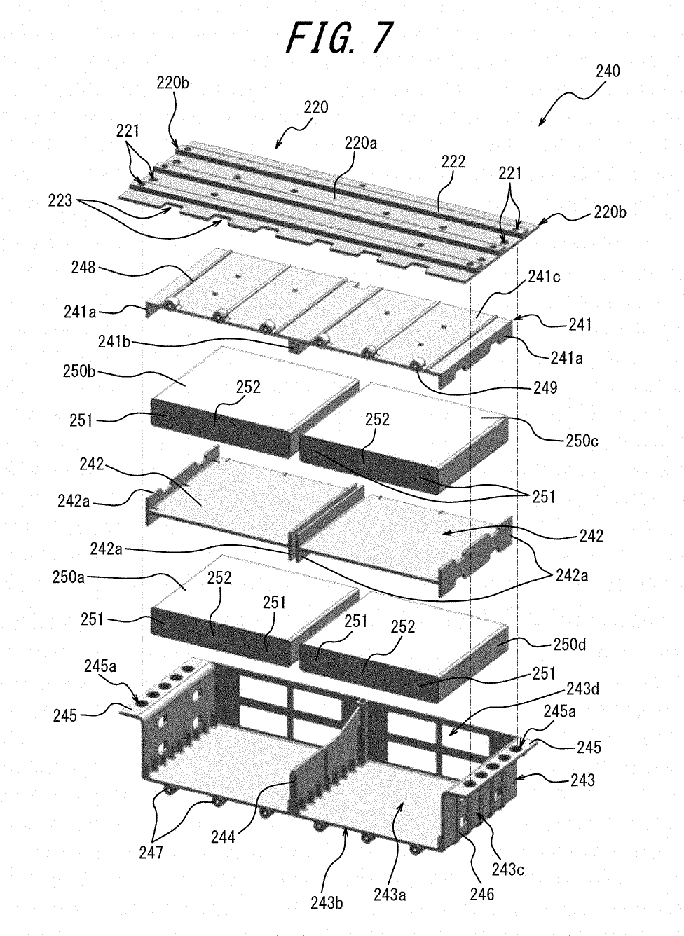

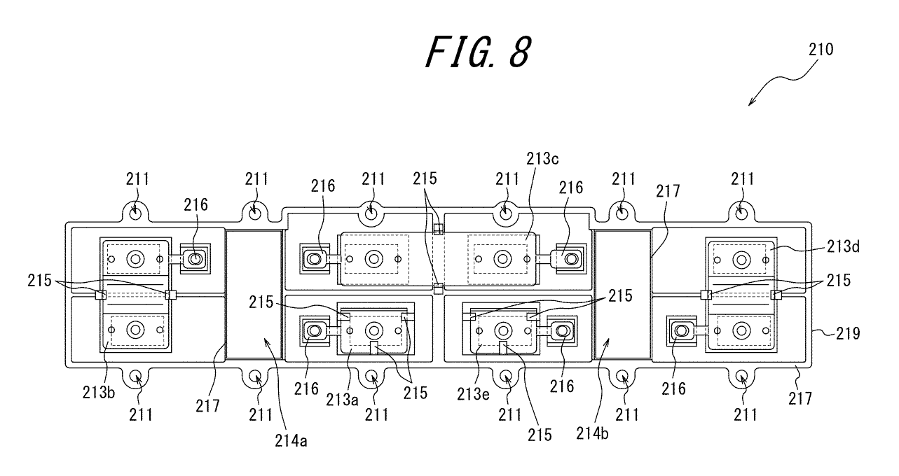

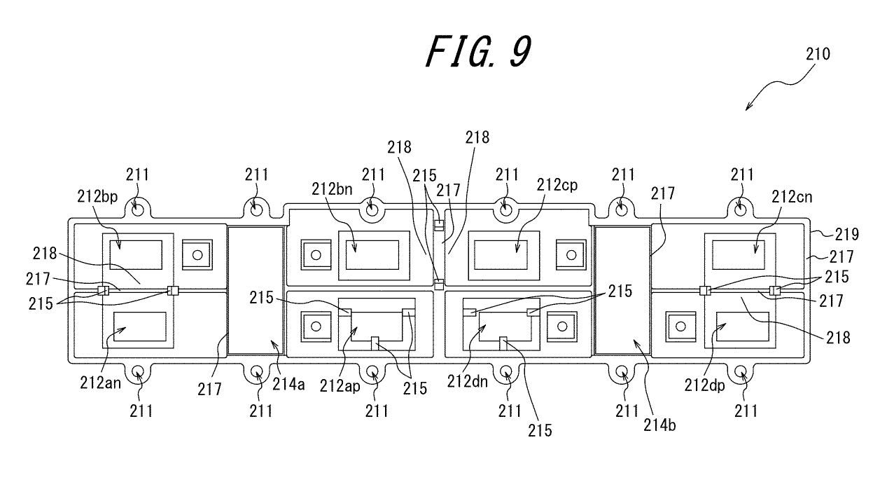

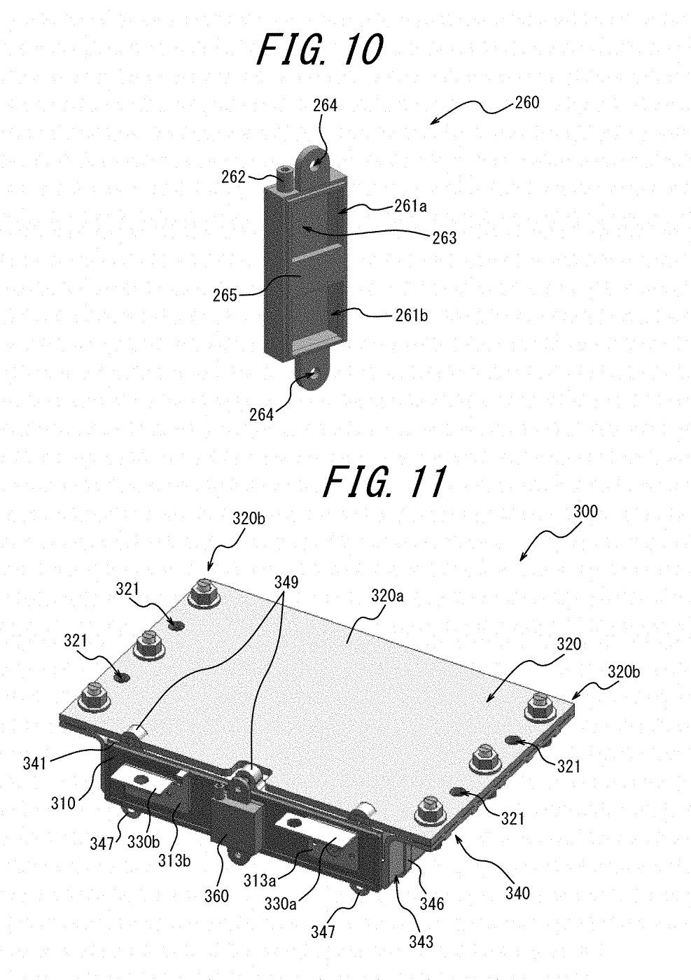

Next, with reference to FIG. 4 through FIG. 10, the four-cell stack assembly 200 that is a battery pack according to an embodiment of the present disclosure is described in detail. FIG. 4 is an external perspective view of the upper side of the four-cell stack assembly 200 included in the power supply device 100 illustrated in FIG. 1. FIG. 5 is an external perspective view of the lower side of the four-cell stack assembly 200 included in the power supply device 100 illustrated in FIG. 1. FIG. 6 illustrates the state of the bus bar plate 210 as mounted on the body of the four-cell stack assembly 200 illustrated in FIG. 4. FIG. 7 is an exploded view of the body of the four-cell stack assembly 200 illustrated in FIG. 4. FIG. 8 is a front view of the bus bar plate 210 included in the four-cell stack assembly 200 illustrated in FIG. 4, i.e. of the bus bar plate 210 according to an embodiment of the present disclosure. FIG. 9 illustrates the bus bar plate 210 in FIG. 8 in a state with the bus bars removed. FIG. 10 is an external perspective view at the back side of the opening valve cover illustrated in FIG. 6.

As illustrated in FIG. 6, the four-cell stack assembly 200 is configured by mounting the bus bar plate 210 onto a body 240 that holds batteries 250a, 250b, 250c, and 250d. The bus bar plate 210 is mounted onto the body 240 at fastening points so as to cover the electrodes of the batteries 250a, 250b, 250c, and 250d. The side of the four-cell stack assembly 200 to which the bus bar plate 210 is mounted is described below as the front. In the present embodiment, the body 240 holds a total of four batteries 250a, 250b, 250c, and 250d in two upper and lower rows and two left and right rows. When looking at the front of the body 240, the battery disposed to the lower left is 250a, the battery disposed to the upper left is 250b, the battery disposed to the upper right is 250c, and the battery disposed to the lower right is 250d. When not distinguishing between the batteries, the batteries are referred to collectively as batteries 250.

As illustrated in FIG. 7, the body 240 is constituted by an upper case 241, a lower case 243, the restraining plate 220 disposed on the upper side of the upper case 241, and a plurality of batteries 250 sandwiched between the upper case 241 and the lower case 243. The plurality of batteries 250 is sandwiched by the upper case 241 and the lower case 243 by fixing the restraining plate 220 to the lower case 243 with the upper case 241 therebetween. An intermediate case 242 is inserted between the two upper and lower rows of batteries 250. The body 240 is substantially cuboid and has a shorter depth in the front and back direction than the width in the lateral direction. The upper case 241, the intermediate case 242, and the lower case 243 are each configured by an insulating resin such as polybutylene terephthalate (PBT). The restraining plate 220 is configured by a metal such as aluminum. In other words, the metal housing 110 of the power supply device 100 and the batteries are insulated from each other by the insulating upper case 241 and lower case 243. The upper case 241 is also referred to below as the first case, the lower case 243 as the second case, and the intermediate case 242 as the third case.

The batteries 250 are, for example, secondary batteries such as a lithium-ion battery or a nickel-hydrogen battery. The batteries 250 are held in the body 240 so that the electrodes 251 face the front. In the present embodiment, each battery 250 has a positive electrode and a negative electrode at both ends in the front view of the body 240. In the front view of the body 240, the lower batteries 250a and 250d are held in the body 240 so that the positive electrodes are at the right end, and the upper batteries 250b and 250c are held in the body 240 so that the positive electrodes are at the left end. In each battery 250, a gas escape hole 252 for emitting gas produced in the battery 250 to the outside is provided at the center between the positive electrode and the negative electrode in the front view of the body 240.

In the front view, the lower case 243 has a concave shape with a space 243a capable of housing the batteries 250 and has a separating plate 244 at the center for separating the batteries 250 housed to the left and right. In other words, the lower case 243 has a bottom 243b that forms a concave shape and side faces 243c that extend upwards from the sides of the bottom 243b in the front view. The upper side of the side faces 243c is formed as an opening 243d. The lower case 243 has a flange 245 that projects towards the outside of the lower case 243 (towards the opposite side from the space 243a) at the upper edge of the side faces 243c.

A plurality of holes 245a that pass through the flange 245 are provided in the flange 245. These holes 245a are provided at positions that correspond to the holes 221 in the restraining plate 220 when the body 240 is assembled. A portion of the holes 245a is used to fix the lower case 243 and the restraining plate 220 by screwing. Another portion of the holes 245a is used for screws to pass through and screw the body 240, including the restraining plate 220, to screw holes 111 provided inside the housing 110.

The lower case 243 has beads 246 projecting from the bottom 243b and extending along the bottom 243b in one direction. As illustrated in FIG. 5, the lower case 243 in the present embodiment has beads 246 extending along the bottom 243b in the longitudinal direction (width direction). The beads 246 extend from the bottom 243b along the side face 243c up to the height of the flange 245. The beads 246 improve the rigidity in the longitudinal direction of the lower case 243 and the body 240. The extending direction of the beads 246 is not limited to the longitudinal direction. For example, the beads 246 may extend in the transverse direction or in yet another, different direction.

The lower case 243 has a plurality of screw hole formation portions 247, the front sides of which are open, on the bottom 243b. The screw hole formation portions 247 are provided projecting downwards from the bottom 243b of the lower case 243. In the present embodiment, the lower case 243 has six screw hole formation portions 247. Specifically, the six screw hole formation portions 247 are provided at the positions closest to four electrodes 251 and two gas escape holes 252 of the lower batteries 250a and 250d when the body 240 is in an assembled state. Screw holes provided in the screw hole formation portions 247 are used for screwing the bus bar plate 210 to the body 240. In other words, the screw hole formation portions 247 constitute fastening points.

The intermediate case 242 is a plate-shaped member including a flat plate portion for separating the batteries 250 provided in the upper and lower rows. One intermediate case 242 is inserted for each pair of upper and lower batteries 250 in the body 240. In other words, the body 240 of the present embodiment includes two intermediate cases 242. The width of the each intermediate case 242 is equivalent to the inner width from the side face 243 c of the lower case 243 to the separating plate 244. The intermediate case 242 includes flanges 242a to the left and right to allow stable arrangement in the space 243a of the lower case 243. The intermediate case 242 is thus formed in an H shape in front view. The flanges 242a have the function of stabilizing and holding the batteries 250 in the space 243a.

The upper case 241 is engaged with the opening 243d side of the lower case 243 from above the two rows of batteries 250 housed in the lower case 243. The width of the upper case 241 is equivalent to the inner width between the side faces 243c of the lower case 243. The upper case 241 has flanges 241a on the left and right that project towards the bottom 243b of the lower case 243 and has a separating plate 241b that projects towards the bottom 243b of the lower case 243 at the center. The upper case 241 is stably disposed inside the space 243a of the lower case 243 by the lateral flanges 241a. Furthermore, the upper case 241 can stably hold the batteries 250 in the space 243a with the lateral flanges 241a and the separating plate 241b.

In a state of engagement with the lower case 243, the upper case 241 has beads 248 projecting from an upper surface 241c and extending along the upper surface 241c in a different direction from the extending direction of the beads 246 of the lower case 243. In a state of engagement with the lower case 243, the beads 248 of the upper case 241 preferably extend in a direction orthogonal to the beads 246 of the lower case 243. In the present embodiment, the upper case 241 has beads 248 extending in the transverse direction (depth direction). The beads 248 improve the rigidity in the transverse direction of the upper case 241 and the body 240. Forming the beads 246 of the lower case 243 and the beads 248 of the upper case 241 to extend in different directions in this way improves the rigidity of the body 240 in a plurality of directions.

The upper case 241 has a plurality of screw hole formation portions 249, the front sides of which are open, on the upper surface 241c. The screw hole formation portions 249 are provided projecting upwards from the upper surface 241c. In the present embodiment, the upper case 241 has six screw hole formation portions 249. Specifically, the six screw hole formation portions 249 are provided at the positions closest to four electrodes 251 and two gas escape holes 252 of the upper batteries 250b and 250c when the body 240 is in an assembled state. Screw holes provided in the screw hole formation portions 249 are used for screwing the bus bar plate 210 to the body 240. In other words, the screw hole formation portions 249 constitute fastening points.

The restraining plate 220 is a substantially flat plate. The width of the restraining plate 220 is equivalent to the width that includes the flanges 245 of the lower case 243. The depth of the restraining plate 220 is equivalent to the depth of the lower case 243. In other words, the restraining plate 220 is formed to cover the entire body 240 in the top view of the body 240. On the front side, notches 223 are provided in the restraining plate 220 at positions corresponding to the screw hole formation portions 249 of the upper case 241. When the restraining plate 220 is fixed to the upper case 241, the notches 223 prevent interference between the restraining plate 220 and the screw hole formation portions 249 that project upwards from the upper surface 241c, and the notches 223 also facilitate close contact between the restraining plate 220 and the upper surface 241c of the upper case 241.

On lateral ends 220b, the restraining plate 220 has a plurality of holes 221 that pass through the restraining plate 220. A portion of the holes 221 is used to fix the lower case 243 and the restraining plate 220 by screwing. By fixing the restraining plate 220 to the flanges 245 of the lower case 243, the weight of the batteries 250 sandwiched between the lower case 243 and the upper case 241 presses on the restraining plate 220. Therefore, the restraining plate 220 has the function of supporting the batteries 250 in the body 240. Another portion of the holes 221 is used for screws to pass through and screw the body 240, including the restraining plate 220, to screw holes 111 provided inside the housing 110.

The restraining plate 220 has beads 222 projecting from a top 220a and extending along the top 220a in one direction. As illustrated in FIG. 7 and the like, the restraining plate 220 in the present embodiment has beads 222 projecting from the top 220a and extending along the top 220a in the longitudinal direction (width direction). The beads 222 improve the rigidity in the longitudinal direction of the restraining plate 220 and the body 240. The extending direction of the beads 222 is not limited to the longitudinal direction. For example, the beads 222 may extend in the transverse direction or in yet another, different direction.

The bus bar plate 210 is mounted on the assembled body 240 from the front side, as illustrated in FIG. 6. The bus bar plate 210 is configured by resin, for example, such as PBT.

As illustrated in FIG. 8, the bus bar plate 210 is a substantially rectangular flat plate that has a plurality of bus bar plate mounting holes 211 on an outer peripheral edge 219 thereof. The bus bar plate mounting holes 211 are provided on the outer peripheral edge 219 of the bus bar plate 210 at close positions to the peripheral edge of the below-described degassing openings and electrode openings included in the bus bar plate. Here, close positions refer to positions at which the distance from the peripheral edge of the degassing openings and electrode openings to the outer peripheral edge 219 of the bus bar plate 210 is shorter than a predetermined distance. The bus bar plate mounting holes 211 are particularly preferably provided at locations for which the distance from the peripheral edge of the degassing openings and electrode openings to the outer peripheral edge 219 of the bus bar plate 210 is closest. In the present embodiment, the bus bar plate mounting holes 211 are provided at positions in the bus bar plate 210 corresponding to the screw hole formation portions 247 or 249 once the bus bar plate 210 is mounted on the body 240. In other words, six bus bar plate mounting holes 211 are provided on each of the upper and lower long sides of the bus bar plate 210. The bus bar plate 210 is mounted onto the body 240 by passing screws through the bus bar plate mounting holes 211 and screwing the screws into screw holes provided in the screw hole formation portions 247 or 249. In other words, the bus bar plate mounting holes 211 constitute fastening points.

As illustrated in FIG. 9, the bus bar plate 210 has electrode openings at positions corresponding to the electrodes of the batteries 250 once the bus bar plate 210 is mounted on the body 240. In other words, the bus bar plate 210 has a total of eight electrode openings. The electrode openings corresponding to the positive electrode and negative electrode of the battery 250a are referred to respectively as a first electrode opening 212ap and a second electrode opening 212an. The electrode openings corresponding to the positive electrode and negative electrode of the battery 250b are referred to respectively as a third electrode opening 212bp and a fourth electrode opening 212bn. The electrode openings corresponding to the positive electrode and negative electrode of the battery 250c are referred to respectively as a fifth electrode opening 212cp and a sixth electrode opening 212cn. The electrode openings corresponding to the positive electrode and negative electrode of the battery 250d are referred to respectively as a seventh electrode opening 212dp and an eighth electrode opening 212dn. When not distinguishing between the electrode openings, the electrode openings are referred to collectively as electrode openings 212. The bus bar plate 210 includes a bus bar on each electrode opening 212 on the front side.

Furthermore, the bus bar plate 210 has degassing openings at positions corresponding to the gas escape holes 252 of the batteries 250 once the bus bar plate 210 is mounted on the body 240. In the present embodiment, one degassing opening is provided at a position corresponding to the gas escape holes 252 of two batteries 250 in the upper and lower rows. In other words, a degassing opening 214a is provided at a position corresponding to the gas escape holes 252 of the batteries 250a and 250b. A degassing opening 214b is provided at a position corresponding to the gas escape holes 252 of the batteries 250c and 250d. However, a total of four degassing openings may instead be provided in the bus bar plate 210 for one-to-one correspondence with the gas escape holes 252 of the batteries.

In the body 240, the bus bar plate mounting holes 211 are provided at the closest positions to the corresponding electrode openings 212 or degassing openings 214a, 214b on the basis of the positional relationships between the above-described screw hole formation portions 247 and 249 on the one hand and the electrodes 251 and gas escape holes 252 of the batteries 250 on the other. When not distinguishing between the degassing openings 214a and 214b, the degassing openings are referred to collectively as degassing openings 214.

As illustrated in FIG. 8, the bus bar plate 210 includes a first bus bar 213a on the first electrode opening 212ap. As illustrated in FIG. 6, the first bus bar 213a has two orthogonal surfaces. One surface is held by three holding claws 215 provided on the bus bar plate 210, and the other surface projects from the bus bar plate 210 towards the front, constituting the positive electrode terminal 230a. The positive electrode terminal 230a constituted by the first bus bar 213a is connected to the current sensor 150. After the bus bar plate 210 is mounted on the body 240, the surface of the first bus bar 213a not constituting the positive electrode terminal 230a is connected to the positive electrode of the battery 250a by laser welding. The holding claws 215 also have the function of temporarily holding the first bus bar 213a before the laser welding. The first bus bar 213a also has a terminal 216 for connecting the current sensor.

Furthermore, as illustrated in FIG. 8, the bus bar plate 210 includes a second bus bar 213b that extends vertically across the second electrode opening 212an and the third electrode opening 212bp. In other words, the second bus bar 213b connects the negative electrode of the battery 250a and the positive electrode of the battery 250b once the bus bar plate 210 is mounted on the body 240. The second bus bar 213b is held by two holding claws 215 provided on the bus bar plate 210. After the bus bar plate 210 is mounted on the body 240, the second bus bar 213b is connected to the negative electrode of the battery 250a at the second electrode opening 212an by laser welding and is connected to the positive electrode of the battery 250b at the third electrode opening 212bp by laser welding. The holding claws 215 also have the function of temporarily holding the second bus bar 213b before the laser welding. The second bus bar 213b also has a terminal 216 for connecting the current sensor.

Furthermore, as illustrated in FIG. 8, the bus bar plate 210 includes a third bus bar 213c that extends horizontally across the fourth electrode opening 212bn and the fifth electrode opening 212cp. In other words, the third bus bar 213c connects to the negative electrode of the battery 250b and the positive electrode of the battery 250c once the bus bar plate 210 is mounted on the body 240. The third bus bar 213c is held by two holding claws 215 provided on the bus bar plate 210. After the bus bar plate 210 is mounted on the body 240, the third bus bar 213c is connected to the negative electrode of the battery 250b at the fourth electrode opening 212bn by laser welding and is connected to the positive electrode of the battery 250c at the fifth electrode opening 212cp by laser welding. The holding claws 215 also have the function of temporarily holding the third bus bar 213c before the laser welding. On the left side of the fourth electrode opening 212bn and on the right side of the fifth electrode opening 212cp, the third bus bar 213c also has respective terminals 216 for connecting the current sensor.

Furthermore, as illustrated in FIG. 8, the bus bar plate 210 includes a fourth bus bar 213d that extends vertically across the sixth electrode opening 212cn and the seventh electrode opening 212dp. In other words, the fourth bus bar 213d connects the negative electrode of the battery 250c and the positive electrode of the battery 250d once the bus bar plate 210 is mounted on the body 240. The fourth bus bar 213d is held by two holding claws 215 provided on the bus bar plate 210. After the bus bar plate 210 is mounted on the body 240, the fourth bus bar 213d is connected to the negative electrode of the battery 250c at the sixth electrode opening 212cn by laser welding and is connected to the positive electrode of the battery 250d at the seventh electrode opening 212dp by laser welding. The holding claws 215 also have the function of temporarily holding the fourth bus bar 213d before the laser welding. The fourth bus bar 213d also has a terminal 216 for connecting the current sensor.

Furthermore, as illustrated in FIG. 8, the bus bar plate 210 includes a fifth bus bar 213e on the eighth electrode opening 212dn. As illustrated in FIG. 6, the fifth bus bar 213e has two orthogonal surfaces. One surface is held by three holding claws 215 provided on the bus bar plate 210, and the other surface projects from the bus bar plate 210 towards the front, constituting the negative electrode terminal 230b. The negative electrode terminal 230b constituted by the fifth bus bar 213e is connected to the positive electrode terminal of the one-cell stack assembly 300. After the bus bar plate 210 is mounted on the body 240, the surface of the fifth bus bar 213e not constituting the negative electrode terminal 230b is connected to the negative electrode of the battery 250e by laser welding. The holding claws 215 also have the function of temporarily holding the fifth bus bar 213e before the laser welding. The fifth bus bar 213e also has a terminal 216 for connecting the current sensor.

The first bus bar 213a through the fifth bus bar 213e are each configured by a conductive metal such as aluminum.

The bus bar plate 210 has a bead 217 that projects towards the front along the entire outer peripheral edge 219. The bus bar plate 210 also has beads 217 that project towards the front along the entire peripheral edge of the degassing openings 214.

Furthermore, at the bus bars that are arranged across two electrode openings, the bus bar plate 210 has a bead 217 that projects towards the front on a plate portion 218 between the two electrode openings. In other words, as illustrated in FIG. 9, the bus bar plate 210 in this embodiment has a bead 217 on a plate portion 218 between the second electrode opening 212an and the third electrode opening 212bp in the second bus bar 213b arranged across the second electrode opening 212an and the third electrode opening 212bp. The bus bar plate 210 also has a bead 217 on a plate portion 218 between the fourth electrode opening 212bn and the fifth electrode opening 212cp in the third bus bar 213c arranged across the fourth electrode opening 212bn and the fifth electrode opening 212cp. The bus bar plate 210 also has a bead 217 on a plate portion 218 between the sixth electrode opening 212cn and the seventh electrode opening 212dp in the fourth bus bar 213d arranged across the sixth electrode opening 212cn and the seventh electrode opening 212dp.

Providing the beads 217 in the bus bar plate 210 in this manner improves the rigidity of the bus bar plate 210 and the four-cell stack assembly overall.

The four-cell stack assembly 200 includes opening valve covers 260 on the degassing openings 214 of the bus bar plate 210. The opening valve covers 260 are, for example, constituted by resin such as PBT. As illustrated in FIG. 10, each opening valve cover 260 has openings 261a and 261b that cover the degassing opening 214 at the back side in the assembled state of the four-cell stack assembly 200. The opening 261a and the opening 261b are separated by a separating plate 265. The openings 261a and 261b separated by the separating plate 265 cover the gas escape hole 252 of each battery 250 when the opening valve covers 260 are assembled into the four-cell stack assembly 200.

The opening valve cover 260 is substantially cuboid and has an interior space 263. The opening valve cover 260 has a substantially cylindrical gas emission duct 262 that connects the interior space 263 with the outside of the opening valve cover 260. A non-illustrated hose is connected to the gas emission duct 262. The gasses emitted from the inside of the batteries 250 flow into the interior space 263 of the opening valve cover 260 through the openings 261a and 261b and combine. The combined gas then passes through the gas emission duct 262 and is emitted to the outside from the hose connected to the gas emission duct 262.

The opening valve cover 260 includes a plurality of opening valve cover mounting holes 264. In the present embodiment, the opening valve cover 260 is mounted onto the body 240 by passing screws through the opening valve cover mounting holes 264 and the bus bar plate mounting holes 211 corresponding to the degassing openings 214 of the bus bar plate 210 and screwing the screws into screw holes provided in the screw hole formation portions 247 or 249. Accordingly, the opening valve cover mounting holes 264 are provided at positions corresponding to the bus bar plate mounting holes 211 that correspond to the degassing openings 214, and the opening valve cover mounting holes 264 constitute fastening points. The outer circumferential dimension of the opening valve cover 260 in front view preferably allows engagement in close contact with the bead 217 provided on the degassing opening 214. In this manner, the bead 217 and the opening valve cover 260 are in close contact when the four-cell stack assembly 200 is in an assembled state. The gas emitted from the batteries 250 can therefore be prevented from flowing outside of the four-cell stack assembly 200.

The opening valve cover 260 is mounted onto the body 240 by being screwed thereon with seals 270 made of rubber, such as EPDM, sandwiched by the openings 261a and 261b to prevent gas from leaking to the outside from the opening valve cover 260.

Next, the one-cell stack assembly 300 is described. FIG. 11 is an external perspective view of the upper side of the one-cell stack assembly 300 included in the power supply device 100 illustrated in FIG. 1. Since the configuration of the one-cell stack assembly 300 is similar to that of the four-cell stack assembly 200, a description is omitted as appropriate for locations identical to the four-cell stack assembly 200.

Like the four-cell stack assembly 200, the one-cell stack assembly 300 is configured by mounting the bus bar plate 310 onto a body 340 that holds a battery. The bus bar plate 310 is mounted onto the body 340 at fastening points so as to cover the electrodes of the battery held by the body 340.

The body 340 of the one-cell stack assembly 300 includes only one battery. The battery is sandwiched by an upper case 341 and a lower case 343. The lower case 343 has beads 346 that extend along the bottom in the width direction. The beads 346 extend to the side faces of the lower case 343. The upper case 341 and the lower case 343 have screw hole formation portions 347 and 349 for fixing the bus bar plate 310 by screwing. In other words, the screw hole formation portions 347 and 349 constitute fastening points.

A restraining plate 320 is disposed on the top of the upper case 341. The restraining plate 320 is fastened to the lower case 343 by screwing, using a portion of holes 321 provided on ends 320b of the restraining plate 320 and holes provided on a flange of the lower case 343. The top 320a of the restraining plate 320 does not have any beads, thereby facilitating mounting of the LBC 130 and the fusible link 140 upon assembly into the power supply device 100.

The bus bar plate 310 is a substantially rectangular flat plate that has a plurality of bus bar plate mounting holes on an outer peripheral edge thereof. The bus bar plate mounting holes of the bus bar plate 310 are provided at positions in the bus bar plate 310 corresponding to the screw hole formation portions 347 or 349 once the bus bar plate 310 is mounted on the body 340.

The bus bar plate 310 has electrode openings at positions corresponding to the positive electrode and the negative electrode of the battery once the bus bar plate 310 is mounted on the body 340. The bus bar plate 310 has a sixth bus bar 313a at the electrode opening corresponding to the positive electrode of the battery. As illustrated in FIG. 11, the sixth bus bar 313a has two orthogonal surfaces. One surface is held by three holding claws provided on the bus bar plate 310, and the other surface projects from the bus bar plate 310 towards the front, constituting the positive electrode terminal 330a. The positive electrode terminal 330a constituted by the sixth bus bar 313a is connected to the negative electrode terminal 230b of the four-cell stack assembly 200.

The bus bar plate 310 also has a seventh bus bar 313b at the electrode opening corresponding to the negative electrode of the battery. As illustrated in FIG. 11, the seventh bus bar 313b has two orthogonal surfaces. One surface is held by three holding claws provided on the bus bar plate 310, and the other surface projects from the bus bar plate 310 towards the front, constituting the negative electrode terminal 330b. The negative electrode terminal 330b constituted by the seventh bus bar 313b is connected to the fusible link 140.

Furthermore, the bus bar plate 310 has degassing openings at positions corresponding to gas escape holes of the battery once the bus bar plate 310 is mounted on the body 340. Like the bus bar plate 210 of the four-cell stack assembly 200, an opening valve cover 360 is mounted on the degassing openings of the bus bar plate 310.

In this manner, the upper case 241 and lower case 243 that hold the batteries 250 can be formed integrally with the restraining plate 220 in the four-cell stack assembly 200 (battery pack) according to the present embodiment. Hence, the weight of the batteries presses on the restraining plate 220. Since the restraining plate 220 is made of metal, deflection caused by the weight of the batteries 250 can more easily be prevented than when the batteries are only held by the upper case 241 and lower case 243 that are made of resin. Therefore, the four-cell stack assembly 200 can readily and appropriately hold the batteries 250. Furthermore, by preventing deflection, the four-cell stack assembly 200 makes it less likely that the relative positions between the plurality of batteries 250 in the body 240 will change. Therefore, the relative positions between the plurality of batteries 250 tend not to change, preventing stress after the laser welding.

In the four-cell stack assembly 200, the batteries 250 are held in the space 243a of the lower case 243. Since the restraining plate 220 is fixed to the lower case 243, the weight of the batteries 250 is more reliably supported by the restraining plate 220.

Furthermore, the restraining plate 220 is less likely to deform when supporting the batteries 250, since the rigidity of the restraining plate 220 is increased by the beads 222. The lower case 243 is also less likely to deform when supporting the batteries 250, since the rigidity of the lower case 243 is increased by the beads 246. Since the beads 248 of the upper case 241 extend in a different direction than the beads 246 of the lower case 243, the rigidity of the battery pack 200 as a whole increases in a plurality of directions.

Since the intermediate case 242 includes the flanges 242a, the batteries are held more stably within the battery pack 200.

Furthermore, the lower case 243 of the battery pack 200 is fixed directly to the housing 110 of the power supply device 100 according to the present embodiment, thereby holding the battery pack 200 more stably within the power supply device 100.

Although the present disclosure is based on embodiments and drawings, it is to be noted that various changes and modifications will be apparent to those skilled in the art based on the present disclosure. Therefore, such changes and modifications are to be understood as included within the scope of the present disclosure. For example, the functions and the like included in the various components may be reordered in any logically consistent way. Furthermore, components may be combined into one or divided.

For example, in the above embodiment, the case of the battery pack being the four-cell stack assembly 200 that includes four batteries 250 has been described, but the battery pack is not limited to the four-cell stack assembly 200. The battery pack can be configured to include any number, two or greater, of batteries 250.

Furthermore, the bus bar plate 210 may, for example, have a bead at a location other than the outer peripheral edge 219, the peripheral edge of the degassing openings 214, and the plate portions 218. For example, the bus bar plate 210 may have beads 217 that project towards the front along the entire peripheral edge of the electrode openings 212.

### REFERENCE SIGNS LIST

100 Power supply device
110 Housing
110a Top
110b Bottom
111 Screw hole
120 Bus bar fixing terminal
130 LBC (battery controller)
140 Fusible link
150 Current sensor
160 ICR relay
170 MOSFET
180 Terminal post
180a, 180b Terminal
190 First secondary battery
200 Four-cell stack assembly (battery pack)
210, 310 Bus bar plate
211 Bus bar plate mounting hole
212 Electrode opening
212ap First electrode opening
212an Second electrode opening
212bp Third electrode opening
212bn Fourth electrode opening
212cp Fifth electrode opening
212cn Sixth electrode opening
212dp Seventh electrode opening
212dn Eighth electrode opening
213a First bus bar
213b Second bus bar
213c Third bus bar
213d Fourth bus bar
213e Fifth bus bar
214, 214a, 214b Degassing opening
215 Holding claw
216 Terminal
217, 246, 248, 346 Bead
218 Plate portion
219 Outer peripheral edge
220, 320 Restraining plate
220a, 320a Top
220b, 320b End
221, 321 Hole
222 Bead
223 Notch
230a, 330a Positive electrode terminal
230b, 330b Negative electrode terminal
240, 340 Body
241, 341 Upper case (first case)
241a, 242a, 245 Flange
241b, 244, 265 Separating plate
241c Top
242 Intermediate case (third case)
243, 343 Lower case (second case)
243a, 263 Space
243b Bottom
243c Side face
243d Opening
245a Hole
247, 249, 347 Screw hole formation portion
250 Battery
251 Electrode
252 Gas escape hole
260, 360 Opening valve cover
261a, 261b Opening
262 Gas emission duct
264 Opening valve cover mounting hole
270 Seal
300 One-cell stack assembly
313a Sixth bus bar
313b Seventh bus bar
400 Power supply system
410 Alternator
420 Starter
430 Second secondary battery
440 Load
450 Switch
460 Controller

1-7. (canceled)

8. A battery pack comprising:
an insulating first case;
an insulating second case configured to house a plurality of batteries between the first case and the second case; and
a restraining plate configured to sandwich the plurality of batteries between the second case and the restraining plate with the first case therebetween, wherein
the first case comprises a first bead extending in one direction, and
the second case comprises a second bead extending in a different direction than the one direction.

9. The battery pack of claim 8, wherein the first bead and the second bead are formed in orthogonal directions.

10. The battery pack of claim 8, wherein
the second case is fastened to the restraining plate at both ends,
the second bead extends in a direction connecting the both ends, and
the restraining plate comprises a bead extending in the same direction as the second bead of the second case.

11. The battery pack of claim 9, wherein
the second case is fastened to the restraining plate at both ends,
the second bead extends in a direction connecting the both ends, and
the restraining plate comprises a bead extending in the same direction as the second bead of the second case.

12. The battery pack of claim 8, wherein the first bead is formed on a surface of the first case abutting the restraining plate.

13. The battery pack of claim 8, wherein the second bead is formed on a surface of the second case opposite a surface of the second case in contact with the plurality of batteries.
